(19) United States
(12) Patent Application Publication
(10) Pub. No.: US 2023/0137913 A1
(43) Pub. Date: May 4, 2023

(54) POLYIMIDE FILMS

(71) Applicant: DUPONT ELECTRONICS, INC., Wilmington, DE (US)

(72) Inventors: Laila MACLAUGHLIN, Stoutsville, OH (US); Daniel Robert Eichel, Grove City, OH (US); Kostantinos Kourtakis, Media, PA (US); Thomas Edward Carney, Orient, OH (US)

(21) Appl. No.: 17/958,675

(22) Filed: Oct. 3, 2022

Related U.S. Application Data
(60) Provisional application No. 63/273,529, filed on Oct. 29, 2021.

(51) Int. Cl. C08G 73/10; C08K 3/04; C08K 3/22

(52) U.S. Cl. CPC C08G 73/1067; C08K 3/04; C08K 3/22; C08K 2003/2227

(57) ABSTRACT

In a first aspect, a polyimide film includes a substantially chemically converted polyimide and at least 10 volume percent of an inorganic filler, based on a total volume of the polyimide film. A void ratio of the polyimide film is 0.75 or less. In a second aspect, a polyimide film includes a substantially chemically converted polyimide and at least 10 volume percent of an organic filler, based on a total volume of the polyimide film. A void ratio of the polyimide film is 1.0 or less.

### FIELD OF DISCLOSURE

The field of this disclosure is polyimide films.

### BACKGROUND OF THE DISCLOSURE

Polyimide films made using a chemical imidization process, also known as chemically converted polyimide films, are significantly less expensive than those derived from a thermal imidization process (thermally converted). This is a consequence of the much higher line speeds and integrated process steps (casting and imidization) that are used in the chemical conversion process, which employs catalysts to facilitate the imidization of polyamic acid to polyimide.

Traditionally, however, chemically converted films with fillers contain macroscopic voids. These voids are considered undesirable, and it has been theorized that in the case of conductivity, such as electrical conductivity and thermal conductivity, they may be associated with the interruption of the connectivity between the filler components in the composite film system, resulting in poor transport properties for these films relative to similar films made using a thermal conversion process. Attempts to make highly filled polyimide films using a chemical imidization process result in films with significantly lower conductivities. In addition to electrical and thermal properties, the presence of voids may play a role in a deterioration of mechanical and/or optical properties in films containing fillers.

U.S. Pat. No. 4,986,946 provides a hybrid process for filled films that attempts to take advantage of benefits of both chemical and thermal imidization processes and avoid void formation by first partially imidizing a polyamic acid using a chemical process and then finishing the imidization using a thermal process. By limiting the chemical conversion to less than 50% imidization, void content in the film is maintained at an intermediate, but relatively low level, permitting some conductive paths to be formed between the particles of the conductive filler, resulting in the observed conductivity. Surface resistivities of films made using this hybrid approach, however, are significantly higher than those of films made using a thermal imidization process.

A filled polyimide film made using a chemical conversion process to fully imidize the film and having a reduced void concentration is greatly desired.

### DETAILED DESCRIPTION

In a first aspect, a polyimide film includes a substantially chemically converted polyimide and at least 10 volume percent of an inorganic filler, based on a total volume of the polyimide film. The substantially chemically converted polyimide is derived from at least 10 mole percent of an aromatic dianhydride having two or more phenyl groups, based on a total dianhydride content of the polyimide, and at least 10 mole percent of an aromatic diamine having two or more phenyl groups, based on a total diamine content of the polyimide. The two or more phenyl groups in the aromatic dianhydride do not share carbon atoms with each other. The two or more phenyl groups in the aromatic diamine do not share carbon atoms with each other. Less than 50 volume percent of the inorganic filler, based on the total inorganic filler, has a diameter of less than 100 nm in all three dimensions. A void ratio of the polyimide film is 0.75 or less.

In a second aspect, a polyimide film includes a substantially chemically converted polyimide and at least 10 volume percent of an organic filler, based on a total volume of the polyimide film. The substantially chemically converted polyimide is derived from at least 10 mole percent of an aromatic dianhydride having two or more phenyl groups, based on a total dianhydride content of the polyimide, and at least 10 mole percent of an aromatic diamine having two or more phenyl groups, based on a total diamine content of the polyimide. The two or more phenyl groups in the aromatic dianhydride do not share carbon atoms with each other. The two or more phenyl groups in the aromatic diamine do not share carbon atoms with each other. Less than 50 volume percent of the organic filler, based on the total organic filler, has a diameter of less than 100 nm in all three dimensions. A void ratio of the polyimide film is 1.0 or less.

Substantially chemically converted polyimide films with more than 10 volume percent filler and low void concentrations can be made through careful selection of the dianhydride and diamine monomers used for the polyimide backbone, allowing for the production of chemically converted polyimide films with transport properties, such as thermal or electrical conductivity, as good as those found in thermally converted polyimide films.

As used herein, the term “substantially chemically converted” means that a polyimide is 75% or more, 80% or more, 85% or more, 90% or more, or 95% or more imidized using a process incorporating conversion chemicals (i.e., catalysts and dehydrating agents) in which a solvated mixture (a polyamic acid casting solution) can be cast or applied onto a support to give a partially imidized gel film, and then heated in an oven, using convective and radiant heat, to remove solvent and complete the imidization. Percent imidization can be measured by comparing a ratio of intensities at 1365 cm⁻¹ (polyimide C—N) relative to 1492 cm⁻¹ (aromatic stretch used as an internal standard) in Attenuated Total Reflectance Fourier Transform Infra-Red (ATR-FTIR) spectroscopy and comparing the ratio to that of a sample prepared with standard curing methods that is defined as being 100% cured.

As used herein, the term “gel film” refers to a layer of polyimide material which is laden with volatiles, primarily solvent, to such an extent that the polyimide is in a gel-swollen, plasticized, rubbery condition. The volatile content is usually in the range of 80 to 90 wt % and the polymer content usually in the range of 10 to 20 wt % of the gel film. The film becomes self-supporting in the gel film stage and can be stripped from the support on which it was cast and heated. The gel film generally has an amic acid to imide ratio between 90:10 and 10:90. This differs from a “green film”, which is either entirely polyamic acid or which has a very low polyimide content. Green film contains generally about 50 to 80% by weight polymer and 20 to 50% by weight solvent and is sufficiently strong to be self-supporting.

As used herein, the term “void” refers to a volume of space within a solid object which is essentially free of any of the components that make up the solid object. For instance, in a polymer film composition having a polymer and fillers, any space within the boundaries of the surfaces and edges of the film that does not contain polymer or filler is a void. A void can have any number of shapes and sizes, and an object can have any number of voids, or no voids at all. A void can be at or near the surface of a solid object and be exposed to the surrounding environment. A volume percent of voids in a solid object can be derived from the dry bulk density of the object and the theoretical void-free density of the object, as described below. The theoretical void-free density is calculated using ideal mixture law (see below). As used herein, the term “void ratio” refers to a ratio of the total volume percent of voids in an object divided by the total volume percent of filler in the object, where the total volume of filler is calculated based on the weight of the filler and its reported density. Voids found within the filler particles are included as part of the total volume of voids for the solid object.

Depending upon context, “diamine” as used herein is intended to mean: (i) the unreacted form (i.e., a diamine monomer); (ii) a partially reacted form (i.e., the portion or portions of an oligomer or other polymer precursor derived from or otherwise attributable to diamine monomer) or (iii) a fully reacted form (the portion or portions of the polymer derived from or otherwise attributable to diamine monomer). The diamine can be functionalized with one or more moieties, depending upon the particular embodiment selected in the practice of the present invention.

Indeed, the term “diamine” is not intended to be limiting (or interpreted literally) as to the number of amine moieties in the diamine component. For example, (ii) and (iii) above include polymeric materials that may have two, one, or zero amine moieties. Alternatively, the diamine may be functionalized with additional amine moieties (in addition to the amine moieties at the ends of the monomer that react with dianhydride to propagate a polymeric chain). Such additional amine moieties could be used to crosslink the polymer or to provide other functionality to the polymer.

Similarly, the term “dianhydride” as used herein is intended to mean the component that reacts with (is complimentary to) the diamine and in combination is capable of reacting to form an intermediate (which can then be cured into a polymer). Depending upon context, “anhydride” as used herein can mean not only an anhydride moiety per se, but also a precursor to an anhydride moiety, such as: (i) a pair of carboxylic acid groups (which can be converted to anhydride by a de-watering or similar-type reaction); or (ii) an acid halide (e.g., chloride) ester functionality (or any other functionality presently known or developed in the future which is) capable of conversion to anhydride functionality.

Depending upon context, “dianhydride” can mean: (i) the unreacted form (i.e. a dianhydride monomer, whether the anhydride functionality is in a true anhydride form or a precursor anhydride form, as discussed in the prior above paragraph); (ii) a partially reacted form (i.e., the portion or portions of an oligomer or other partially reacted or precursor polymer composition reacted from or otherwise attributable to dianhydride monomer) or (iii) a fully reacted form (the portion or portions of the polymer derived from or otherwise attributable to dianhydride monomer).

The dianhydride can be functionalized with one or more moieties, depending upon the particular embodiment selected in the practice of the present invention. Indeed, the term “dianhydride” is not intended to be limiting (or interpreted literally) as to the number of anhydride moieties in the dianhydride component. For example, (i), (ii) and (iii) (in the paragraph above) include organic substances that may have two, one, or zero anhydride moieties, depending upon whether the anhydride is in a precursor state or a reacted state. Alternatively, the dianhydride component may be functionalized with additional anhydride type moieties (in addition to the anhydride moieties that react with diamine to provide a polymer). Such additional anhydride moieties could be used to crosslink the polymer or to provide other functionality to the polymer.

Any one of a number of polymer manufacturing processes may be used to prepare polymer films. It would be impossible to discuss or describe all possible manufacturing processes useful in the practice of the present invention. It should be appreciated that the monomer systems of the present invention are capable of providing the above-described advantageous properties in a variety of manufacturing processes. The compositions of the present invention can be manufactured as described herein and can be readily manufactured in any one of many (perhaps countless) ways of those of ordinarily skilled in the art, using any conventional or non-conventional manufacturing technology.

Although methods and materials similar or equivalent to those described herein can be used in the practice or testing of the present invention, suitable methods and materials are described herein.

When an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

In describing certain polymers, it should be understood that sometimes applicants are referring to the polymers by the monomers used to make them or the amounts of the monomers used to make them. While such a description may not include the specific nomenclature used to describe the final polymer or may not contain product-by-process terminology, any such reference to monomers and amounts should be interpreted to mean that the polymer is made from those monomers or that amount of the monomers, and the corresponding polymers and compositions thereof.

The materials, methods, and examples herein are illustrative only and, except as specifically stated, are not intended to be limiting.

As used herein, the terms “comprises,” “comprising,” “includes,” “including,” “has,” “having” or any other variation thereof, are intended to cover a non-exclusive inclusion. For example, a method, process, article, or apparatus that comprises a list of elements is not necessarily limited only those elements but may include other elements not expressly listed or inherent to such method, process, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of the “a” or “an” are employed to describe elements and components of the invention. This is done merely for convenience and to give a general sense of the invention. This description should be read to include one or at least one and the singular also includes the plural unless it is obvious that it is meant otherwise.

It will be understood that although the terms first, second, third, etc. may be used herein to describe various elements, components, regions, layers and/or sections, these elements, components, regions, layers, and/or sections should not be limited by these terms. These terms are only used to distinguish one element, component, region, layer and/or section from another element, component, region, layer and/or section. Thus, a first element, component, region, layer and/or section could be termed a second element, component, region, layer and/or section without departing from the teachings of the present invention. Similarly, the terms “top” and “bottom” are only relative to each other. It will be appreciated that when an element, component, layer or the like is inverted, what is the “bottom” before being inverted would be the “top” after being inverted, and vice versa. When an element is referred to as being “on” or “disposed on” another element, it means positioning on or below the object portion, but does not essentially mean positioning on the upper side of the object portion based on a gravity direction, and it can be directly on the other element or intervening elements may be present therebetween. In contrast, when an element is referred to as being “directly on” or “disposed directly on” another element, there are no intervening elements present.

Further, it will also be understood that when one element, component, region, layer and/or section is referred to as being “between” two elements, components, regions, layers and/or sections, it can be the only element, component, region, layer and/or section between the two elements, components, regions, layers and/or sections, or one or more intervening elements, components, regions, layers and/or sections may also be present.

### Organic Solvents

Useful organic solvents for the synthesis of the polyamides of the present invention are preferably capable of dissolving the polyimide precursor materials. Such a solvent should also have a relatively low boiling point, such as below 225° C., so the polymer can be dried at moderate (i.e., more convenient and less costly) temperatures. A boiling point of less than 210, 205, 200, 195, 190, or 180° C. is preferred.

Useful organic solvents include: N-methylpyrrolidone (NMP), dimethylacetamide (DMAc), methyl ethyl ketone (MEK), N,N′-dimethyl-formamide (DMF), dimethyl sulfoxide (DMSO), tetramethyl urea (TMU), glycol ethyl ether, diethyleneglycol diethyl ether, 1,2-dimethoxyethane (monoglyme), diethylene glycol dimethyl ether (diglyme), 1,2-bis-(2-methoxyethoxy) ethane (triglyme), gamma-butyrolactone, and bis-(2-methoxyethyl) ether, tetrahydrofuran (THF), ethyl acetate, hydroxyethyl acetate glycol monoacetate, acetone and mixtures thereof. In one embodiment, preferred solvents include N-methylpyrrolidone (NMP) and dimethylacetamide (DMAc).

### Diamines

In one embodiment, an aromatic diamine having two or more phenyl groups can be used for forming the polyimide, wherein the two or more phenyl groups in the aromatic diamine do not share carbon atoms with each other. These flexible linkages may provide more conformational degrees of freedom to the polyimide backbone formed from the diamine, thereby limiting the formation of voids in a polyimide derived from these monomers. Aromatic diamines with two or more phenyl groups bonded with a flexible linkage can include fluorinated aromatic diamines, such as 2,2′-bis (trifluoromethyl)benzidine (TFMB), 2,2′-bis-(4-aminophenyl)hexafluoropropane, 4,4′-diamino-2,2′-trifluoromethyldiphenyloxide, 3,3′-diamino-5,5′-trifluoromethyldiphenyloxide, 9,9′-bis(4-aminophenyl)fluorene, 4,4′-trifluoromethyl-2,2′-diaminobiphenyl, 4,4′-oxy-bis[2-trifluoromethyl)benzeneamine] (1,2,4-OBABTF), 4,4′-oxy-bis[3-trifluoromethyl)benzeneamine], 4,4′-thiobis[(2-trifluoromethyl)benzeneamine], 4,4′-thiobis[(3-trifluoromethyl)benzeneamine], 4,4′-sulfoxyl-bis[(2-trifluoromethyl) benzeneamine, 4,4′-sulfoxyl-bis[(3-trifluoromethyl)benzeneamine], 4,4′-keto-bis[(2-trifluoromethyl)benzeneamine], 1,1-bis[4′-(4″-amino-2″-trifluoromethylphenoxy) phenyl]cyclopentane, 1,1-bis[4′-(4″-amino-2″-trifluoromethylphenoxy) phenyl]cyclohexane, 2-trifluoromethyl-4,4′-diaminodiphenylether; 1,4-(2′-trifluoromethyl-4′,4″-diaminodiphenoxy)benzene, 1,4-bis(4′-aminophenoxy)-2-[(3′,5′-ditrifluoromethyl)phenyl]benzene (6F-amine), 1,4-bis[2′-cyano-3′(″4-amino phenoxy)phenoxy]-2-[(3′,5′-ditrifluoro-methyl)phenyl]benzene (6FC-diamine), 3,5-diamino-4-methyl-2′,3′,5′,6′-tetrafluoro-4′-tri-fluoromethyldiphenyloxide, 2,2-bis[4(4-aminophenoxy) phenyl]phthalein-3′,5′-bis(trifluoromethyl)anilide (6FADAP) and 3,3′,5,5′-tetrafluoro-4,4′-diamino-diphenylmethane (TFDAM).

Other useful diamines with two or more phenyl groups bonded with a flexible linkage can include 4,4′-diaminobiphenyl, 4,4″-diaminoterphenyl, 4,4′-diaminobenzanilide (DABA), 4,4′-diaminophenylbenzoate, 4,4′-diaminobenzophenone, 4,4′-diaminodiphenylmethane (MDA), 4,4′-diaminodiphenylsulfide, 4,4′-diaminodiphenylsulfone, 3,3′-diaminodiphenylsulfone, bis[4-(4-aminophenoxy) phenyl]sulfone (BAPS), 4,4′-bis(4-aminophenoxy)biphenyl (BAPB), 4,4′-diaminodiphenylether (ODA), 3,4′-diaminodiphenylether, 4,4′-isopropylidenedianiline, 2,2′-bis(3-aminophenyl)propane, 2,2-bis(4-aminophenyl)propane, 3,3′-dimethyl-4,4′-diaminobiphenyl, 4-aminophenyl-3-aminobenzoate, bis(p-beta-amino-t-butylphenyl) ether, p-bis-2-(2-methyl-4-aminopentyl)benzene. In one embodiment, the diamine is a triamine, such as N,N-bis(4-aminophenyl)-n-butylamine, N,N-bis(4-aminophenyl) methylamine or N,N-bis(4-aminophenyl)aniline.

Other useful diamines with two or more phenyl groups bonded with a flexible linkage can include 1,2-bis(4-aminophenoxy)benzene, 1,3-bis(4-aminophenoxy) benzene (RODA), 1,2-bis(3-aminophenoxy)benzene, 1,3-bis(3-aminophenoxy) benzene, 1-(4-aminophenoxy)-3-(3-aminophenoxy)benzene, 1,4-bis-(4-aminophenoxy) benzene, 1,4-bis(3-aminophenoxy)benzene, 1-(4-aminophenoxy)-4-(3-aminophenoxy) benzene, 2,2-bis(4-[4-aminophenoxy]phenyl)propane (BAPP), 2,2′-bis(4-phenoxyaniline) isopropylidene. In one embodiment, a substantially chemically converted polyimide can be derived from at least 10 mol %, at least 20 mol %, at least 30 mol %, at at least 40 mol %, or at least 50 mol % of an aromatic diamine having two or more phenyl groups, wherein the two or more phenyl groups in the aromatic diamine do not share carbon atoms with each other.

In one embodiment, additional diamines for forming the polyimide can include monomers that do not have two or more phenyl groups bonded with a flexible linkage. These additional diamines can include p-phenylenediamine (PPD), m-phenylenediamine (MPD), 2,5-dimethyl-1,4-diaminobenzene, 2,5-dimethyl-1,4-phenylenediamine (DPX), 1,4-naphthalenediamine, 1,5-naphthalenediamine, 1,5-diaminonaphthalene, m-xylylenediamine, and p-xylylenediamine.

Other useful additional diamines for forming the polyimide can include an aliphatic diamine, such as 1,2-diaminoethane, 1,6-diaminohexane (HMD), 1,4-diaminobutane, 1,5 diaminopentane, 1,7-diaminoheptane, 1,8-diaminooctane, 1,9-diaminononane, 1,10-diaminodecane (DMD), 1,11-diaminoundecane, 1,12-diaminododecane (DDD), 1,16-hexadecamethylenediamine, 1,3-bis(3-aminopropyl)-tetramethyldisiloxane, trans-1,4-diaminocyclohexane (CHDA), isophoronediamine (IPDA), bicyclo[2.2.2]octane-1,4-diamine and combinations thereof. Other aliphatic diamines suitable for practicing the invention include those having six to twelve carbon atoms or a combination of longer chain and shorter chain diamines so long as both developability and flexibility of the polymer are maintained. Long chain aliphatic diamines may increase flexibility.

Other useful additional diamines for forming the polyimide can include an alicyclic diamine (can be fully or partially saturated), such as a cyclobutane diamine (e.g., cis- and trans-1,3-diaminocyclobutane, 6-amino-3-azaspiro[3.3]heptane, and 3,6-diaminospiro [3.3]heptane), bicyclo[2.2.1]heptane-1,4-diamine, isophoronediamine, and bicyclo[2.2.2]octane-1,4-diamine. Other alicyclic diamines can include cis-1,4-cyclohexanediamine, trans-1,4-cyclohexanediamine, 1,4-bis(aminomethyl)cyclohexane, 4,4′-methylenebis(cyclohexylamine), 4,4′-methylenebis(2-methyl-cyclohexylamine), bis(aminomethyl)norbornane.

### Dianhydrides

In one embodiment, an aromatic dianhydride having two or more phenyl groups can be used in forming the polyimide, wherein the two or more phenyl groups in the aromatic dianhydride do not share carbon atoms with each other. As described above for the diamines, these flexible linkages may provide more conformational degrees of freedom to the polyimide backbone formed from the dianhydride, thereby limiting the formation of voids in a polyimide derived from these monomers. The dianhydrides can be used in their tetra-acid form (or as mono, di, tri, or tetra esters of the tetra acid), or as their diester acid halides (chlorides). However, in some embodiments, the dianhydride form can be preferred, because it is generally more reactive than the acid or the ester.

Examples of suitable aromatic dianhydrides having two or more phenyl groups bonded with a flexible linkage include 3,3′,4,4′-biphenyltetracarboxylic dianhydride (BPDA), 2-(3′,4′-dicarboxyphenyl)-5,6-dicarboxybenzimidazole dianhydride, 2-(3′,4′-dicarboxyphenyl)-5,6-dicarboxybenzoxazole dianhydride, 2-(3′,4′-dicarboxyphenyl)-5,6-dicarboxybenzothiazole dianhydride, 2,2′,3,3′-benzophenonetetracarboxylic dianhydride, 2,3,3′,4′-benzophenonetetracarboxylic dianhydride, 3,3′,4,4′-benzophenonetetracarboxylic dianhydride (BTDA), 2,2′,3,3′-biphenyltetracarboxylic dianhydride, 2,3,3′,4′-biphenyltetracarboxylic dianhydride, 4,4′-thio-diphthalic anhydride, bis (3,4-dicarboxyphenyl)sulfone dianhydride, bis(3,4-dicarboxyphenyl) sulfoxide dianhydride (DSDA), bis(3,4-dicarboxyphenyloxadiazole-1,3,4)-p-phenylene dianhydride, bis(3,4-dicarboxyphenyl)-2,5-oxadiazole-1,3,4-dianhydride, bis(3′,4′-dicarboxydiphenylether)-2,5-oxadiazole-1,3,4-dianhydride, 4,4′-oxydiphthalic anhydride (ODPA), bis(3,4-dicarboxyphenyl)thioether dianhydride, bisphenol A dianhydride (BPADA), bisphenol S dianhydride, bis-1,3-isobenzofurandione, 1,4-bis(4,4′-oxyphthalic anhydride)benzene, bis(3,4-dicarboxyphenyl) methane dianhydride, perylene-3,4,9,10-tetracarboxylic dianhydride, 1,3-bis-(4,4′-oxydiphthalic anhydride)benzene, 2,2-bis(3,4-dicarboxyphenyl)propane dianhydride, 4,4′-(hexafluoroisopropylidene)diphthalic anhydride (6FDA) and 9,9-bis (trifluoromethyl)-2,3,6,7-xanthenetetracarboxylic dianhydride. In one embodiment, a substantially chemically converted polyimide can be derived from at least 10 mol %, at least 20 mol %, at least 30 mol % or at least 50 mol % of an aromatic dianhydride having two or more phenyl groups, wherein the two or more phenyl groups in the aromatic dianhydride do not share carbon atoms with each other.

In one embodiment, additional dianhydrides for forming the polyimide can include monomers that do not have two or more phenyl groups bonded with a flexible linkage. These additional dianhydrides can include 1,2,5,6-naphthalenetetracarboxylic dianhydride, 1,4,5,8-naphthalenetetracarboxylic dianhydride, 2,3,6,7-naphthalenetetracarboxylic dianhydride, bicyclo-[2,2,2]-octen-(7)-2,3,5,6-tetracarboxylic-2,3,5,6-dianhydride, cyclopentadienyltetracarboxylic dianhydride, ethylenetetracarboxylic dianhydride, pyromellitic dianhydride (PMDA), tetrahydrofurantetracarboxylic dianhydride, 2,6-dichloronaphthalene-1,4,5,8-tetracarboxylic dianhydride, 2,7-dichloronaphthalene-1,4,5,8-tetracarboxylic dianhydride, 2,3,6,7-tetrachloronaphthalene-1,4,5,8-tetracarboxylic dianhydride, phenanthrene-1,8,9,10-tetracarboxylic dianhydride, pyrazine-2,3,5,6-tetracarboxylic dianhydride, benzene-1,2,3,4-tetracarboxylic dianhydride and thiophene-2,3,4,5-tetracarboxylic dianhydride.

In one embodiment, additional dianhydrides for forming the polyimide can include an alicyclic dianhydride, such as cyclobutane-1,2,3,4-tetracarboxylic dianhydride (CBDA), 1,2,4,5-cyclohexanetetracarboxylic dianhydride, 1,2,3,4-cyclohexanetetracarboxylic dianhydride, 1,2,3,4-tetramethyl-1,2,3,4-cyclobutanetetracarboxylic dianhydride, 1,2,3,4-cyclopentanetetracarboxylic dianhydride (CPDA), hexahydro-4,8-ethano-1H,3H-benzo[1,2-c:4,5-c′]difuran-1,3,5,7-tetrone (BODA), 3-(carboxymethyl)-1,2,4-cyclopentanetricarboxylic 1,4:2,3-dianhydride (TCA), and meso-butane-1,2,3,4-tetracarboxylic dianhydride.

In one embodiment a substantially chemically converted polyimide can have a weight-average molecular weight (M_{w}) of 100,000 daltons or more, 150,000 daltons or more, 200,000 daltons or more, or 250,000 daltons or more.

### Imidization Catalysts

In one embodiment, an imidization catalyst (sometimes called an “imidization accelerator”) can be used as a conversion chemical that can help lower the imidization temperature for forming the polyimide and shorten the imidization time. The polyamic acid casting solutions of the present invention comprises both a polyamic acid solution combined with some amount of conversion chemicals. The conversion chemicals found to be useful in the present invention include, but are not limited to, (i) one or more dehydrating agents and/or co-catalysts, such as, aliphatic acid anhydrides (acetic anhydride, trifluoroacetic anhydride, propionic anhydride, monochloroacetic anhydride, bromo adipic anhydride, etc.) and aromatic acid anhydrides; and (ii) one or more imidization catalysts, such as, aliphatic tertiary amines (triethylamine, etc.), aromatic tertiary amines (dimethylaniline, N,N-dimethyl benzylamine, etc.) and heterocyclic tertiary amines (pyridine, alpha, beta, gamma, picoline, 3,5-lutidine, 3,4-lutidene, isoquinoilne, etc.) and guanidines (e.g. tetramethylguanidine). In one embodiment, an imidization catalyst does not include a diazole. Other useful dehydrating agents can include diacetyl oxide, butyryl oxide, benzoyl oxide, 1,3-dichlorohexyl carbodiimide, N, N-dicyclohexyl carbodiimide, benzenesulfonyl chloride, thionyl chloride and phosphorus pentachloride. In some embodiments, the dehydrating agent can also act as a catalyst to enhance the reaction kinetics for the imidization. The anhydride dehydrating material is typically used in a slight molar excess of the amount of amide acid groups present in the polyamic acid solution. In one embodiment, the amount of dehydrating agent used is typically about 2.0 to 4.0 moles per equivalent of the polyamic acid formula unit. Generally, a comparable amount of tertiary amine catalyst is used. The ratio of these catalysts and their concentration in the polyamic acid solution will influence imidization kinetics and the film properties. Polyimide films having substantially chemically converted polyimide can have imidization catalysts present in the polyimide film in an amount in the range of from 1 part per billion (ppb) to 1 wt %, from 10 ppb to 0.1 wt %, or from 100 ppb to 0.01 wt %.

### Fillers

In one embodiment, a filler for a polyimide film can include an inorganic filler, an organic filler or a mixture thereof. In some embodiments, the fillers are spherical, oblong, needle-like or platelet in shape. Inorganic fillers can include thermally conductive fillers, metal oxides, inorganic nitrides and metal carbides, and electrically conductive fillers like metals (e.g., gold, silver, copper, etc.). In one embodiment inorganic fillers can include diamond, clay, talc, sepiolite, mica, dicalcium phosphate, metal oxides, including magnetic metal oxides, transparent conducting oxides and fumed metal oxides. In one embodiment, inorganic fillers can include inorganic oxides, such as oxides of silicon, aluminum, zinc and titanium, hollow (porous) silicon oxide, antimony oxide, zirconium oxide, indium tin oxide, antimony tin oxide, mixed titanium/tin/zirconium oxides, and binary, ternary, quaternary and higher order oxides of one or more cations selected from silicon, titanium, aluminum, antimony, zirconium, indium, tin, zinc, niobium and tantalum. In one embodiment, particle composites (e.g. single or multiple core/shell structures) can be used, in which one oxide encapsulates another oxide in one particle.

In one embodiment, inorganic fillers can include other ceramic compounds, such as boron nitride, aluminum nitride, ternary or higher order compounds containing boron, aluminum and nitrogen, gallium nitride, silicon nitride, aluminum nitride, zinc selenide, zinc sulfide, zinc telluride, silicon carbide, and their combinations, or higher order compounds containing multiple cations and multiple anions.

In one embodiment, organic fillers can include polyaniline, polythiophene, polypyrrole, polyphenylenevinylene, polydialkylfluorenes, carbon black, graphite, graphene, multiwalled and single walled carbon nanotubes, and other nanotube structures, and carbon nanofibers. In one embodiment, low color organic fillers, such as polydialkylfluorenes, can also be used.

In one embodiment, fillers for a polyimide film can have a median particle size, d₅₀, in a range of from 0.1 to 10 μm, from 0.1 to 5 μm, from 0.2 to 5 μm, or from 0.2 to 3 μm. Filler size can be determined using a laser particle size analyzer, with the filler dispersed in an organic solvent (optionally with the aid of a dispersant, adhesion promoter, and/or coupling agent). The median particle size, d₅₀, is the equivalent spherical diameter based on a median volume distribution of the particles. If the median particle size is smaller than 0.1 μm, the filler particles can tend to agglomerate, or become unstable, in the organic solvents used in polyimide manufacturing. If the median particle size of the agglomerated particles exceeds 10 μm the dispersion of the filler component in the polyimide film may be too non-homogeneous (or unsuitably large for the thickness of the film). In one embodiment, a ratio of the median particle size of filler to the thickness of the polyimide film in which it is contained is less than 0.30, less than 0.29, less than, 0.28, less than 0.27, less than 0.26, less than 0.25, or less than 0.20 to 1. A relatively non-homogenous dispersion of the filler component in the film can result in poor mechanical elongation of the film, poor flex life of the film, and/or low dielectric strength. In one embodiment, fillers may require extensive milling and filtration to breakup unwanted particle agglomeration as is typical when attempting to disperse some fillers into a polymer matrix. Such milling and filtration can be costly and may not be capable of removing all unwanted agglomerates. In one embodiment, the average aspect ratio of the filler can be 1 or greater. In some embodiments, the filler is selected from the group consisting of needle-like fillers (acicular), fibrous fillers, platelet fillers, polymer fibers, and mixtures thereof. In one embodiment, the fillers can have an aspect ratio of at least 1, at least 2, at least 4, at least 6, at least 8, at least 10, at least 12, at least 15, at least 25, at least 50, at least 100, at least 200, or at least 300 to 1. In some embodiments, one or more additional fillers that have a d₅₀ of less than 100 nm in all three dimensions can be used in a blend of different fillers.

In one embodiment electrically insulating thermally conductive fillers can include diamond, clay, talc, sepiolite, mica, dicalcium phosphate, metal oxides, including magnetic metal oxides, transparent conducting oxides and fumed metal oxides. In one embodiment, inorganic fillers can include inorganic oxides, such as oxides of silicon, aluminum, zinc and titanium, hollow (porous) silicon oxide, antimony oxide, zirconium oxide, and binary, ternary, quaternary and higher order oxides of one or more cations selected from silicon, titanium, aluminum, antimony, zirconium, indium, tin, zinc, niobium and tantalum. In one embodiment, particle composites (e.g., single or multiple core/shell structures) can be used, in which one oxide encapsulates another oxide in one particle.

In one embodiment, thermally conductive fillers can include other ceramic compounds, such as boron nitride, aluminum nitride, ternary or higher order compounds containing boron, aluminum and nitrogen, gallium nitride, silicon nitride, aluminum nitride, zinc selenide, zinc sulfide, zinc telluride, silicon carbide, and their combinations, or higher order compounds containing multiple cations and multiple anions and can include oxycarbides and oxynitrides.

In one embodiment, electrically conductive fillers can include metals (such as gold, silver, copper, etc.), conducting mixed-metal oxides (such as cuprates, superconducting oxides, indium tin oxide, antimony tin oxide, mixed titanium/tin/zirconium oxides, etc.), organic fillers, such as polyaniline, polythiophene, polypyrrole, polyphenylenevinylene, polydialkylfluorenes, carbon black, graphite, graphene, multiwalled and single walled carbon nanotubes, and other nanotube structures, and carbon nanofibers. In one embodiment, low color organic fillers, such as polydialkylfluorenes, can also be used. In one embodiment particle composites (e.g., single or multiple core/shell structures) can be used, in which one type of filler encapsulates another type of filler in one particle. For example, an electrically insulating thermally conductive material can be used as a core and an electrically conductive material can form the shell of the composite particle.

In one embodiment, an electrically conductive filler is carbon black. In one embodiment, the electrically conductive filler is selected from the group consisting of acetylene blacks, super abrasion furnace blacks, conductive furnace blacks, conductive channel type blacks, carbon nanotubes, carbon fibers, fine thermal blacks and mixtures thereof. As described above for low conductivity carbon black, oxygen complexes on the surface of the carbon particles act as an electrically insulating layer. Thus, low volatility content is generally desired for high conductivity. However, it is also necessary to consider the difficulty of dispersing the carbon black. Surface oxidation enhances deagglomeration and dispersion of carbon black. In some embodiments, when the electrically conductive filler is carbon black, the carbon black has a volatile content less than or equal to 1%.

In some embodiments, the filler includes a mixture, or blend, of fillers having any number of particle types, particle sizes and particle shapes, wherein a mixture, or blend, can be of the same type of filler or a different type of filler. In some embodiments, fillers can include less than 50 volume percent, based on the total amount of filler in the polyimide film, of sub-micron fillers having a particle diameter of 100 nm or less in all three dimensions. In other embodiment, fillers can include less than 40, less than 30, less than 20 or less than 10 volume percent, based on the total amount of filler in the polyimide film, of sub-micron fillers having a particle diameter of 100 nm or less in all three dimensions. In one embodiment, sub-micron fillers can include colloidal nanoparticles. Sub-micron fillers can include the compositions and particle shapes as described above for inorganic and organic fillers.

In one embodiment, fillers can be coated with a coupling agent. For example, a filler particle can be coated with an aminosilane, phenylsilane, acrylic or methacrylic coupling agents derived from the corresponding alkoxysilanes. Trimethylsilyl surface capping agents can be introduced to the particle surface by reaction of the fillers with hexamethyldisilazane. In one embodiment, fillers can be coated with a dispersant. In one embodiment, fillers can be coated with a combination of a coupling agent and a dispersant. Alternatively, the coupling agent, dispersant or a combination thereof can be incorporated directly into the polymer film and not necessarily coated onto the fillers.

### Polyimide Films

In one embodiment, a polyimide film can be produced using a chemical conversion process by combining a diamine and a dianhydride (monomer or other polyimide precursor form) together with a solvent to form a polyamic acid (also called a polyamide acid) solution. The dianhydride and diamine can be combined in a molar ratio of about 0.90 to 1.10. The molecular weight of the polyamic acid formed therefrom can be adjusted by adjusting the molar ratio of the dianhydride and diamine.

In one embodiment, a polyamic acid casting solution is derived from the polyamic acid solution. The polyamic acid casting solution, and/or the polyamic acid solution, are combined with conversion chemicals like: (i) one or more dehydrating agents, such as, aliphatic acid anhydrides (acetic anhydride, etc.) and/or aromatic acid anhydrides; and (ii) one or more catalysts, such as, aliphatic tertiary amines (triethyl amine, etc.), aromatic tertiary amines (dimethyl aniline, etc.) and heterocyclic tertiary amines (pyridine, picoline, isoquinoline, etc.). The anhydride dehydrating material it is often used in molar excess compared to the amount of amide acid groups in the polyamic acid. The amount of acetic anhydride used is typically about 2.0 to 4.0 moles per equivalent (repeat unit) of polyamic acid. Generally, a comparable amount of tertiary amine catalyst is used. Fillers, dispersed or suspended in solvent as described above, are then added to the polyamic acid solution.

In one embodiment, the polyamic acid solution is dissolved in an organic solvent at a concentration from about 5.0 or 10 percent to 15, 20, 25, 30, 35 or 40 percent by weight. In one embodiment, a slurry comprising a filler is prepared, where the slurry has a solids content in a range of from 0.1 to 70, from 0.5 to 60, from 1 to 55, from 5 to 50, or from 10 to 45 percent by weight. The slurries may or may not be milled using a ball mill to reach the desired particle size. The slurries may or may not be filtered to remove any residual large particles. A polyamic acid solution can be made by methods well known in the art. The polyamic acid solution may or may not be filtered. In some embodiments, the solution is mixed in a high shear mixer with the filler slurry. When a polyamic acid solution is made with a slight excess of diamine, additional dianhydride solution may or may not be added to increase the viscosity of the mixture to the desired level for film casting. The amount of the polyamic acid solution, and filler slurry can be adjusted to achieve the desired loading levels in the cured film. In some embodiments, the mixture is cooled below 10° C. and mixed with conversion chemicals prior to casting.

The solvated mixture (the polyamic acid casting solution) can then be cast or applied onto a support, such as an endless belt or rotating drum, to give a partially imidized gel film. Alternatively, it can be cast on a polymeric carrier such as PET, other forms of Kapton® polyimide film (e.g., Kapton® HN or Kapton® E films) or other polymeric carriers. The gel film may be stripped from the drum or belt, placed on a tenter frame, and cured in an oven, using convective and radiant heat to remove solvent and complete the imidization to greater than 98% solids level. The film can then be separated from the support, oriented such as by tentering, with continued heating (drying and curing) to provide a substantially chemically converted polyimide film.

Useful methods for producing polyimide films using a chemical conversion method can be found in U.S. Pat. Nos. 5,166,308 and 5,298,331, which are incorporate by reference into this specification for all teachings therein. Numerous variations are also possible, such as,
(a) A method wherein the diamine components and dianhydride components are preliminarily mixed together and then the mixture is added in portions to a solvent while stirring.
(b) A method wherein a solvent is added to a stirring mixture of diamine and dianhydride components. (contrary to (a) above)
(c) A method wherein diamines are exclusively dissolved in a solvent and then dianhydrides are added thereto at such a ratio as allowing to control the reaction rate.
(d) A method wherein the dianhydride components are exclusively dissolved in a solvent and then amine components are added thereto at such a ratio to allow control of the reaction rate.
(e) A method wherein the diamine components and the dianhydride components are separately dissolved in solvents and then these solutions are mixed in a reactor.
(f) A method wherein the polyamic acid with excessive amine component and another polyamic acid with excessive dianhydride component are preliminarily formed and then reacted with each other in a reactor, particularly in such a way as to create a non-random or block copolymer.
(g) A method wherein a specific portion of the amine components and the dianhydride components are first reacted and then the residual diamine components are reacted, or vice versa.
(h) A method wherein the conversion chemicals (catalysts) are mixed with the polyamic acid to form a polyamic acid casting solution and then cast to form a gel film.
(i) A method wherein the components are added in part or in whole in any order to either part or whole of the solvent, also where part or all of any component can be added as a solution in part or all of the solvent.
(j) A method of first reacting one of the dianhydride components with one of the diamine components giving a first polyamic acid. Then reacting another dianhydride component with another amine component to give a second polyamic acid. Then combining the amic acids in any one of a number of ways prior to film formation.

In one embodiment, the solvated mixture (the polyamic acid casting solution) can be mixed with a crosslinking precursor and/or a colorant, such as a pigment or a dye, and then cast to form a polymer film. In one embodiment, the colorant may be a low conductivity carbon black. In one embodiment, a polymer film contains a crosslinked polymer in a range of from 80 to 99 wt %. In some embodiments, the polymer film contains between and including any two of the following: 80, 85, 90, 95 and 99 wt % crosslinked polymer. In yet another embodiment, the polymer film contains 91 to 98 wt % crosslinked polymer.

In one embodiment, a crosslinking reaction includes chemical compounds, such as reactive amines, that can participate in a chemical reaction that crosslinks the polymer chains in the film. In one embodiment, heat may be used to crosslink the polymer. In one embodiment, irradiation with a light source may be used to crosslink the polymer through a photoinitiated process. In one embodiment, an additional reactive chemical species may be used to crosslink the polymer. In one embodiment, any combination of these processes may be used to crosslink the polymer.

Crosslinking of the polymer can be determined by a variety of methods. In one embodiment, the gel fraction of polymer may be determined by using an equilibrium swelling method, comparing the weight of a dried film before and after crosslinking. In one embodiment, a crosslinked polymer can have a gel fraction in the range of from 20 to 100%, from 40 to 100%, from 50 to 100%, from 70 to 100%, or from 85 to 100%. In one embodiment, the crosslinked network can be identified using rheological methods. An oscillatory time sweep measurement at specific strain, frequency, and temperature can be used to confirm the formation of crosslinked network. Initially, the loss modulus (G″) value is higher than the storage modulus (G′) value, indicating that the polymer solution behaves like a viscous liquid. Over time, the formation of a crosslinked polymer network is evidenced by the crossover of G′ and G″ curves. The crossover, referred to as the “gel point”, represents when the elastic component predominates over the viscous.

In one embodiment, filler is first dispersed in a solvent to form a slurry. The slurry is then dispersed in the polyamic acid solution. In one embodiment, the concentration of filler to polyimide (in the final film) is in the range of from 10 to 50 vol %, from 15 to 45 vol %, from 15 to 40 vol %, from 20 to 35 vol %, or from 25 to 30 vol %. In one embodiment, the concentration of filler to polyimide (in the final film) is at least 10, at least 15, at least 20, or at least 25 vol %. The composition of the cured film can be calculated from the composition of the components in the mixtures, excluding DMAc solvent (which is removed during curing) and accounting for removal of water during conversion of polyamic acid to polyimide. When using thermal and/or electrically conductive fillers, as the concentration of the filler increases, the conductivity of the polyimide film also increases. In one embodiment, a thermally conductive polyimide film can have a thermal conductivity in a range of from 0.1 to 100 watts per meter-Kelvin (W/m-K), from 0.1 to 50 W/m-K, from 0.15 to 10 W/m-K, from 0.2 to 5 W/m-K, from 0.25 to 1 W/m-K, from 0.25 to 0.8 W/m-K, or from 0.3 to 0.6 W/m-K. In one embodiment, a thermally conductive film can have a dielectric strength in the range of from 1000 to 9000, from 2000 to 8000, from 3000 to 8000, from 5000 to 8000, or from 6000 to 8000 V/mil. In one embodiment, an electrically conductive polyimide film can have a surface resistivity in a range of from 0.5 ohm/square to 2 Megaohm/square, from 2 to 10,000 ohm/square, from 5 to 5000 ohm/square, from 10 to 1000 ohm/square, or from 20 to 500 ohm/square.

In one embodiment, the filled polyamic acid casting solution is a blend of a polyamic acid solution and filler. In this casting solution, the filler is present in a concentration range from 0.1 to 70 vol %, from 1 to 60 vol %, from 2 to 50 vol %, from 5 to 45 vol %, or from 5 to 40 vol %. In one embodiment, the filler is first dispersed in the same polar aprotic solvent used to make the polyamic acid solution (e.g., DMAc). Optionally, a small amount of polyamic acid solution may be added to the filler slurry to increase the viscosity of the slurry. Optionally, a dispersant or dispersing agent may be added to aid in dispersion or alter the rheology of the slurry.

In one embodiment, blending of the filler slurry with a polyamic acid solution to form the filled polyamic acid casting solution is done using high sheer mixing. In this embodiment, if the filler is present beyond 50 volume percent in the final film, the film can be too brittle and may not be sufficiently flexible to form a freestanding, mechanically tough, flexible sheet. Moreover, if the filler is present at a level of less than 10 volume percent, the films formed therefrom may not be sufficiently conductive.

In one embodiment, the casting solution can further comprise any one of a number of additives, such as processing aids (e.g., oligomers), antioxidants, light stabilizers, flame retardant additives, anti-static agents, heat stabilizers, ultraviolet absorbing agents or various reinforcing agents.

In some embodiments, a coextrusion process can be used to form a multilayer polyimide film with an inner core layer sandwiched between two outer layers. In this process, a finished polyamic acid solution is filtered and pumped to a slot die, where the flow is divided in such a manner as to form the first outer layer and the second outer layer of a three-layer coextruded film. In some embodiments, a second stream of polyimide is filtered, then pumped to a casting die, in such a manner as to form the middle polyimide core layer of a three-layer coextruded film. The flow rates of the solutions can be adjusted to achieve the desired layer thickness.

In some embodiments, the multilayer film is prepared by simultaneously extruding the first outer layer, the core layer and the second outer layer. In some embodiments, the layers are extruded through a single or multi-cavity extrusion die. In another embodiment, the multilayer film is produced using a single-cavity die. If a single-cavity die is used, the laminar flow of the streams should be of high enough viscosity to prevent comingling of the streams and to provide even layering. In some embodiments, the multilayer film is prepared by casting from the slot die onto a moving stainless-steel belt to form a partially imidized multilayer gel film. The gel film may be stripped from the drum or belt, placed on a tenter frame, and cured in an oven, using convective and radiant heat to remove solvent and complete the imidization to greater than 98% solids level. The multilayer film can then be separated from the support, oriented such as by tentering, with continued heating (drying and curing) to provide the multilayer substantially chemically converted polyimide film.

The thickness of the polyimide film may be adjusted, depending on the intended purpose of the film or final application specifications. In one embodiment, the polyimide film has a total thickness in a range of from 2 to 300 μm, from 5 to 200 μm, from 10 to 150 μm, from 20 to 100 μm, or from 20 to 80 μm.

By reducing the concentration and volume of voids in a filled polyimide film, films with good electrical and/or thermal conductivity can be produced. Reducing the voids can also lead to improved mechanical, optical, and mass transport properties of polyimide films. By using a chemical conversion process to produce substantially imidized filled polyimide films having low void concentrations, films can be made at lower costs than their thermally imidized counterparts.

### Applications

In one embodiment, electrically insulating thermally conductive polyimide films are useful as substrates (a dielectric) in electronic devices requiring good thermal conductivity of the dielectric material. Examples of such electronic devices include (but are not limited) thermal interface materials (TIM), thermoelectric modules, thermoelectric coolers, DC/AC and AC/DC inverters, DC/DC and AC/AC converters, power amplifiers, voltage regulators, igniters, light emitting diodes, IC packages, and the like. In one embodiment, in order to improve conformability to mating surfaces, and reduce the thermal contact resistance of a TIM assembly, a soft thermal interface layer (having a hardness less than the core of the polyimide film) may be coated or laminated to a thermally conductive polyimide film having a substantially chemically converted polyimide and a low void content. In one embodiment, a soft thermal interface can be part of the outer layers of a multilayer polyimide film.

In one embodiment, electrically conductive polyimide films are useful as thin, flexible heaters that may be used for flexible or rigid applications and are particularly suited for high-voltage, high-temperature applications over large areas, such as windmill blades, leading edges of aircraft wings and helicopter blades, where the prevention of snow and/or ice accumulation is desired. While high-voltage, high-temperature applications are particularly well suited for these film-based heating devices, one of skill in the art could envision using these heating devices for other heating applications, such as low-voltage, low-temperature applications, low-voltage, high-temperature applications and high-voltage, low-temperature applications. Other examples of high temperature applications include clothing irons, hair straightening irons and industrial heater applications. In one embodiment, film-based heating devices may also be useful as wall heaters, floor heaters, roof heaters and seat heaters. In one embodiment, electrically conductive polyimide films can also be used in various applications requiring good antistatic properties such as copier belts, space blankets and flexible circuit substrates. In one embodiment, electrically conductive polyimide films can also be used as electromagnetic interference (EMI) shielding layers.

The advantageous properties of this invention can be observed by reference to the following examples that illustrate, but do not limit, the invention. All parts and percentages are by weight unless otherwise indicated.

### EXAMPLES

### Test Methods

### Void Ratio

Void ratio is defined as a ratio of the total volume percent of voids in a film divided by the total volume percent of filler in the film (i.e., Void ratio=[Void percent]/[volume percent filler]). Total volume percent of voids in the film (which may also be referred to interchangeably as percent voids, void percent, or percent porosity) is determined by the following calculation:

$$Void percent = 100 ⨯ ( 1 - \frac{dry bulk density}{theoretical void ‐ free density} )$$

### Theoretical Void-Free Density

The theoretical void-free density of a film is calculated using the ideal mixture assumption: the total volume of the mixture (the film) is equal to the sum of the individual volumes of each component in the mixture, and the total mass is equal to the sum of the masses of each individual component, giving the following relationship for the theoretical void-free density:

$$ρ = \frac{{\sum }_{i = 1}^{n} {m}_{i}}{{\sum }_{i = 1}^{n} {v}_{i}}$$

Where ρ=density of the film, n=integer number of components, mᵢ=mass of the i^{th} component, vᵢ=volume of the i^{th} component. The individual volume of each component is calculated by the known final solids mass quantity input, and known individual component densities, as follows:

υᵢ=mᵢ/ρᵢ

The densities for the solids discussed in the Examples are as follows:

| Component | Density (g/cc) |
|---|---|
| Boron Nitride | 2.28 |
| α-Al₂O₃ | 3.92 |
| Carbon Black | 1.90 |
| Unfilled PMDA/BPDA//ODA-derived polyimide film | 1.38 |
| Unfilled PMDA/ODPA//RODA-derived polyimide film | 1.38 |
| Unfilled PMDA//ODA-derived polyimide film | 1.42 |

The polyimide film densities are calculated as dry bulk density, as described below, and filler densities are from literature and vendor documentation.

### Dry Bulk Density

The dry bulk volume of films was determined by measurement of their physical dimensions. Point thickness was measured in accordance with standard ASTM D3716 at 5 locations on a 4″ by 6″ specimen and averaged (specimen produced with a precision die cutter, giving a sample area known to within 1% precision). The mass of the specimen was determined using a laboratory balance to 0.0001 g precision. The dry bulk density was then calculated in grams per cubic centimeter from the relationship:

$$Dry bulk density = ( \frac{mass ( g )}{thickness ( μm ) ⨯ area ( {m}^{2} )} )$$

### Particle Size

Median particle size, d₅₀ (the equivalent spherical diameter based on a median volume distribution of the particles), of filler particles in the slurries was measured by laser diffraction using a particle size analyzer (Mastersizer 3000, Malvern Instruments, Inc., Westborough, Mass.). DMAc was used as the carrier fluid.

### Thermal Conductivity

Thermal conductivity was measured using a thermal interface material (TIM) tester (TIM 1400, Analysis Tech Inc., Wakefield, Mass.) in accordance with standard ASTM D5470-17. Polyimide films were treated as Type III materials and run at a sample pressure of 150 psi using silicone oil as a thermal grease.

### Dielectric Strength

Dielectric strength was measured using a dielectric breakdown tester (730-1 AC, Hipotronics Inc, Brewster, N.Y.) in accordance with standard ASTM D149-20, Method A, at 60 Hz, with a 500 V/s rise time, in air at 23° C. and 50% relative humidity, and using a brass electrode (¼″ diameter opposing rods with an edge radius of 1/32). The average of 5-10 individual measurements were recorded.

### Surface Resistivity

Following ASTM D257, to measure surface resistivity, a Loresta AX MCP-T370 equipped with a PSP Linear 4-point probe (Mitsubiushi Chemical Analytech Co., LTD, Kanagawa, Japan) was used to measure surface resistivity in 15 locations spread evenly across a ˜12″×12″ piece of film. The 15 measurements were averaged to determine the surface resistivity of the film.

### Examples 1 and 2

For Examples 1 and 2 (E1-E2), with a monomer composition of PMDA 0.2/ODPA 0.8//RODA, 27.67 kg of 1,3-bis(4-aminophenoxy)benzene (RODA) and 229.06 kg of dimethyl acetamide (DMAc) were added to a nitrogen purged 80-gallon reactor while stirring. The solution was stirred to completely dissolve the RODA in the DMAc solvent and stirring continued during all subsequent steps. The reaction mixture was heated to ˜ 40° C. for this procedure. Approximately 23 kg of 4,4′-oxydiphthalic anhydride (ODPA) and ˜ 2.2 kg of pyromellitic dianhydride (PMDA) were added in four separate aliquots over a 3-hour period. Additional aliquots totaling ˜ 0.45 kg of PMDA were added to the reaction mixture over a period of ˜ 1 hour. The viscosity of the polyamic acid was ˜ 367 poise at 29° C.

### Examples 3 to 6

For Examples 3 to 6 (E3-E6), with a monomer composition of PMDA 0.46/BPDA 0.54//ODA, 26.13 kg of 4,4′-oxydianiline (ODA) and 212.28 kg of DMAc were added to a nitrogen purged 80-gallon reactor while stirring. The solution was stirred to completely dissolve the ODA in the DMAc solvent and stirring continued during all subsequent steps. The reaction mixture was heated to ˜ 40° C. for this procedure. Approximately 5 kg of biphenyl tetracarboxylic acid dianhydride (BPDA) and ˜ 3 kg of pyromellitic dianhydride (PMDA) were added in four separate aliquots over a 2-hour period. Additional aliquots totaling ˜ 0.68 kg of PMDA were added to the reaction mixture over a period of ˜ 1 hour. The viscosity of the polyamic acid solution was ˜ 78 poise at 21° C.

### Comparative Examples 1 to 3

For Comparative Examples 1 to 3 (CE1-CE3), with a monomer composition of PMDA//ODA, a polyamic acid solution in DMAc, was prepared by conventional means, with excess diamine, to a viscosity in a range of from 50 to 100 poise. The polyamic acid solution was 20.6% solids.

### Alpha Alumina Slurry

For some embodiments, an alpha alumina (α-Al₂O₃) slurry was prepared, consisting of 37-50 wt % α-Al₂O₃ powder (Martoxid® MZS-1, Huber Engineered Materials, Atlanta, Ga.), 3-8 wt % polyamic acid solids and 47-58 wt % DMAc. The ingredients were thoroughly mixed in a high-speed disc-type disperser. In some embodiments the slurry was then processed in a bead mill to disperse any agglomerates and to achieve the desired particle size. Median particle size, d₅₀, was 1.4 to 2.2 μm.

### Carbon Black Slurry

For some embodiments a carbon black slurry was prepared, consisting of 10-18 wt % carbon black powder (Conductex® 7055U, Aditya Birla Group, Marietta, Ga.), 3 wt % polyamic acid solids and 63-73 wt % DMAc. The ingredients were thoroughly mixed in a high-speed disc-type disperser. In some embodiments, the slurry was then processed in a bead mill to disperse any agglomerates and to achieve the desired particle size. Median particle size was 0.3 to 5.0 μm. In some embodiments, a dispersing agent was used for improved processing.

For E1-E6 and CE1-CE3, viscosity was adjusted by controlling the amount of dianhydride in the polyamic acid composition. Filler slurries, in the appropriate ratio to produce the desired composition after curing, were then added into the polyamic acid solution and mixed using a high shear mixer. The polymer mixture was cooled to approximately 6° C., conversion chemicals acetic anhydride (˜ 0.14 cm³/cm³ polymer solution) and beta-picoline (˜ 0.15 cm³/cm³ polymer solution) were added and mixed. From the polyamic acid solution, a film was cast using a slot die onto a ˜ 90° C. rotating drum. The resulting gel film was stripped off the drum and fed into a tenter oven, where it was dried and cured to a solids level greater than 98%, using convective and radiant heating. The composition of the cured film was calculated from the composition of the components in the mixtures, excluding DMAc solvent (which is removed during curing) and accounting for removal of water during conversion of polyamic acid to polyimide.

Examples are summarized in Tables 1 and 2.

TABLE 1

| | | | | Theoretical | | | | |
|---|---|---|---|---|---|---|---|---|
| | | | | Void Free | Dry Bulk | | Dielectric | Thermal |
| | Polyimide | α-Al₂O₃ | α-Al₂O₃ | Density | Density | Void | Strength | Conductivity |
| Example | Composition | (wt %) | (vol %) | (g/cc) | (g/cc) | Ratio | (V/mil) | (W/m-K) |
| E1 | PMDA/ODPA//RODA | 26 | 11 | 1.660 | 1.576 | 0.46 | 6617 | 0.27 |
| E2 | PMDA/ODPA//RODA | 55 | 29 | 2.145 | 2.023 | 0.19 | 4787 | 0.42 |
| E3 | PMDA/BPDA//ODA | 51 | 27 | 2.056 | 1.992 | 0.12 | 4199 | 0.45 |
| E4 | PMDA/BPDA//ODA | 60 | 35 | 2.261 | 1.927 | 0.43 | 4659 | 0.45 |
| E5 | PMDA/BPDA//ODA | 64 | 39 | 2.369 | 1.689 | 0.74 | 4647 | 0.36 |
| CE1 | PMDA//ODA | 43 | 21 | 1.957 | 1.572 | 0.92 | 4496 | 0.27 |

Polyimide films E1-E5 all have polyimides derived from at least 10 mole percent of an aromatic dianhydride having two or more phenyl groups, based on a total dianhydride content of the polyimide, and at least 10 mole percent of an aromatic diamine having two or more phenyl groups, based on a total diamine content of the polyimide. Even at filler loadings of 39 vol % (E5), the void ratio is relatively low and the thermal conductivity remains good. By contrast, CE1, having a polyimide that is not derived from at least 10 mole percent of an aromatic dianhydride having two or more phenyl groups, based on a total dianhydride content of the polyimide, and at least 10 mole percent of an aromatic diamine having two or more phenyl groups, based on a total diamine content of the polyimide, has a higher void ratio and lower thermal conductivity, even though the filler loading is only 21 vol %. In addition, the dielectric strengths of E1-E5 remain good, even at the higher filler loading levels.

TABLE 2

| | | | | Theoretical | | | | Surface |
|---|---|---|---|---|---|---|---|---|
| | | | | Void Free | Dry Bulk | | | Resistivity |
| | Polyimide | Carbon | Carbon | Density | Density | Void | Thickness | (ohms/ |
| Example | Composition | (wt %) | (vol %) | (g/cc) | (g/cc) | Ratio | (μm) | square) |
| E6 | PMDA/BPDA//ODA | 36 | 29 | 1.529 | 1.501 | 0.06 | 51 | 94 |
| CE2 | PMDA//ODA | 36 | 29 | 1.560 | 1.069 | 1.08 | 86 | 209 |
| CE3 | PMDA//ODA | 44 | 36 | 1.595 | 0.826 | 1.32 | 127 | 137 |

Polyimide film E6 has a polyimide derived from at least 10 mole percent of an aromatic dianhydride having two or more phenyl groups, based on a total dianhydride content of the polyimide, and at least 10 mole percent of an aromatic diamine having two or more phenyl groups, based on a total diamine content of the polyimide. At a filler loading of 29 vol %, it has an extremely low void ratio and low surface resistivity. By contrast, CE2-CE3, both having polyimides that are not derived from at least 10 mole percent of an aromatic dianhydride having two or more phenyl groups, based on a total dianhydride content of the polyimide, and at least 10 mole percent of an aromatic diamine having two or more phenyl groups, based on a total diamine content of the polyimide, have much higher void ratios and higher surface resistivity at comparable filler loadings.

### Comparative Examples 4 and 5

For Comparative Examples 4 and 5 (CE4-CE5), with a monomer composition of PMDA//ODA, a polyamic acid solution in DMAc, was prepared by conventional means, with excess diamine, to a viscosity of about 2000 poise. The polyamic acid solution was about 20% solids. Carbon slurry was then added into the polyamic acid solution and mixed using a planetary centrifugal mixer. The polymer mixture was cast onto a Mylar® PET sheet. The sheet was placed in a 1:1 mixture of acetic anhydride and beta-picoline for 8 min. The web was then peeled from the Mylar and clamped onto a frame. CE4 was then placed in an oven, heated and dried for 30 min at 300° C. For CE5, a hybrid water extraction process was used that attempts to take advantage of benefits of both chemical and thermal imidization processes and avoid void formation in films by first partially imidizing a polyamic acid using a chemical process and then finishing the imidization using a thermal process. CE5 was clamped onto a frame and then immersed in a mixture of 1 part by volume DMAc in 9 parts distilled water. After soaking for 10 min, CE5 was removed, allowed to drain, placed in an oven, heated and dried for 30 min at 300° C.

CE4-CE5, both having polyimides that are not derived from at least 10 mole percent of an aromatic dianhydride having two or more phenyl groups, based on a total dianhydride content of the polyimide, and at least 10 mole percent of an aromatic diamine having two or more phenyl groups, based on a total diamine content of the polyimide, have very high void ratios. Table 3 summarizes the film properties of CE4-CE5.

TABLE 3

| | | | | Theoretical | | | |
|---|---|---|---|---|---|---|---|
| | | | | Void Free | Dry Bulk | | |
| | Polyimide | Carbon | Carbon | Density | Density | Void | Thickness |
| Example | Composition | (wt %) | (vol %) | (g/cc) | (g/cc) | Ratio | (μm) |
| CE4 | PMDA//ODA | 20 | 16 | 1.496 | 1.260 | 1.00 | 25 |
| CE5 | PMDA//ODA | 20 | 16 | 1.496 | 1.267 | 0.97 | 33 |

What is claimed is:

1. A polyimide film comprising:
a substantially chemically converted polyimide derived from at least 10 mole percent of an aromatic dianhydride having two or more phenyl groups, based on a total dianhydride content of the polyimide, and at least 10 mole percent of an aromatic diamine having two or more phenyl groups, based on a total diamine content of the polyimide; and
at least 10 volume percent of an inorganic filler, based on a total volume of the polyimide film, wherein:
the two or more phenyl groups in the aromatic dianhydride do not share carbon atoms with each other;
the two or more phenyl groups in the aromatic diamine do not share carbon atoms with each other;
less than 50 volume percent of the inorganic filler, based on the total inorganic filler, has a diameter of less than 100 nm in all three dimensions; and
a void ratio of the polyimide film is 0.75 or less.

2. The polyimide film of claim 1, further comprising an imidization catalyst selected from the group consisting of aliphatic acid anhydrides, aromatic acid anhydrides, aliphatic tertiary amines, aromatic tertiary amines and heterocyclic tertiary amines.

3. The polyimide film of claim 1, wherein the aromatic dianhydride having two or more phenyl groups is selected from the group consisting of 3,3′,4,4′-biphenyltetracarboxylic dianhydride, 2,3,3′,4′-biphenyltetracarboxylic dianhydride, bis(3,4-dicarboxyphenyl) sulfoxide dianhydride, 4,4′-oxydiphthalic anhydride, bisphenol A dianhydride, perylene-3,4,9,10-tetracarboxylic dianhydride, 1,3-bis-(4,4′-oxydiphthalic anhydride)benzene, 4,4′-(hexafluoroisopropylidene)diphthalic anhydride, 9,9-bis (trifluoromethyl)-2,3,6,7-xanthenetetracarboxylic dianhydride and mixtures thereof.

4. The polyimide film of claim 1, wherein the aromatic diamine having two or more phenyl groups is selected from the group consisting of 2,2′-bis(trifluoromethyl)benzidine, 2,2′-bis-(4-aminophenyl)hexafluoropropane, 9,9′-bis(4-aminophenyl)fluorene, 2,2-bis[4(4-aminophenoxy)phenyl]phthalein-3′,5′-bis(trifluoromethyl)anilide, 4,4′-diaminobiphenyl, 4,4′-diaminobenzanilide, 4,4′-diaminobenzophenone, bis[4-(4-aminophenoxy) phenyl]sulfone, 4,4′-bis(4-aminophenoxy)biphenyl, 4,4′-diaminodiphenylether, 3,4′-diaminodiphenylether, 4,4′-diaminobenzophenone, 4,4′-isopropylidenedianiline, 2,2-bis(4-aminophenyl)propane, 1,2-bis(4-aminophenoxy) benzene, 1,3-bis(4-aminophenoxy)benzene, 1,4-bis-(4-aminophenoxy) benzene, 2,2-bis(4-[4-aminophenoxy]phenyl)propane and mixtures thereof.

5. The polyimide film of claim 1, wherein the inorganic filler comprises a metal oxide, an inorganic nitride, or a metal carbide.

6. The polyimide film of claim 1, wherein the polyimide film has a dielectric strength in the range of from 1000 to 9000 volts per mil (V/mil).

7. The polyimide film of claim 1, wherein the polyimide film has a thermal conductivity in a range of from 0.2 to 5 watts per meter-Kelvin (W/m-K).

8. The polyimide film of claim 1, wherein the polyimide film has a surface resistivity in a range of from 0.5 ohm/square to 2 Megaohm/square.

9. A polyimide film comprising:
a substantially chemically converted polyimide derived from at least 10 mole percent of an aromatic dianhydride having two or more phenyl groups, based on a total dianhydride content of the polyimide, and at least 10 mole percent of an aromatic diamine having two or more phenyl groups, based on a total diamine content of the polyimide; and
at least 10 volume percent of an organic filler, based on a total volume of the polyimide film, wherein:
the two or more phenyl groups in the aromatic dianhydride do not share carbon atoms with each other;
the two or more phenyl groups in the aromatic diamine do not share carbon atoms with each other;
less than 50 volume percent of the organic filler, based on the total organic filler, has a diameter of less than 100 nm in all three dimensions; and
a void ratio of the polyimide film is 1.0 or less.

10. The polyimide film of claim 9, further comprising an imidization catalyst selected from the group consisting of aliphatic acid anhydrides, aromatic acid anhydrides, aliphatic tertiary amines, aromatic tertiary amines and heterocyclic tertiary amines.

11. The polyimide film of claim 9, wherein the aromatic dianhydride having two or more phenyl groups is selected from the group consisting of 3,3′,4,4′-biphenyltetracarboxylic dianhydride, 2,3,3′,4′-biphenyltetracarboxylic dianhydride, bis(3,4-dicarboxyphenyl) sulfoxide dianhydride, 4,4′-oxydiphthalic anhydride, bisphenol A dianhydride, perylene-3,4,9,10-tetracarboxylic dianhydride, 1,3-bis-(4,4′-oxydiphthalic anhydride)benzene, 4,4′-(hexafluoroisopropylidene)diphthalic anhydride, 9,9-bis (trifluoromethyl)-2,3,6,7-xanthenetetracarboxylic dianhydride and mixtures thereof.

12. The polyimide film of claim 9, wherein the aromatic diamine having two or more phenyl groups is selected from the group consisting of 2,2′-bis(trifluoromethyl)benzidine, 2,2′-bis-(4-aminophenyl)hexafluoropropane, 9,9′-bis(4-aminophenyl)fluorene, 2,2-bis[4(4-aminophenoxy)phenyl]phthalein-3′,5′-bis(trifluoromethyl)anilide, 4,4′-diaminobiphenyl, 4,4′-diaminobenzanilide, 4,4′-diaminobenzophenone, bis[4-(4-aminophenoxy) phenyl]sulfone, 4,4′-bis(4-aminophenoxy)biphenyl, 4,4′-diaminodiphenylether, 3,4′-diaminodiphenylether, 4,4′-diaminobenzophenone, 4,4′-isopropylidenedianiline, 2,2-bis(4-aminophenyl)propane, 1,2-bis(4-aminophenoxy) benzene, 1,3-bis(4-aminophenoxy)benzene, 1,4-bis-(4-aminophenoxy) benzene, 2,2-bis(4-[4-aminophenoxy]phenyl)propane and mixtures thereof.

13. The polyimide film of claim 9, wherein the organic filler comprises a carbon black, a graphite, a graphene, a nanotube structure, or a carbon nanofiber.

14. The polyimide film of claim 9, wherein the polyimide film has a dielectric strength in the range of from 1000 to 9000 volts per mil (V/mil).

15. The polyimide film of claim 9, wherein the polyimide film has a thermal conductivity in a range of from 0.1 to 100 watts per meter-Kelvin (W/m-K).

16. The polyimide film of claim 9, wherein the polyimide film has a surface resistivity in a range of from 0.5 ohm/square to 2 Megaohm/square.
